(19) United States
(12) Patent Application Publication
(10) Pub. No.: US 2016/0094437 A1
(43) Pub. Date: Mar. 31, 2016

(54) METHOD AND SYSTEMS FOR INTELLIGENT CALL ROUTING

(71) Applicant: VONAGE NETWORK LLC, Holmdel, NJ (US)

(72) Inventor: Guy Bar On, Tel-Aviv (IL)

(21) Appl. No.: 14/501,466

(22) Filed: Sep. 30, 2014

(51) Int. Cl. H04L 12/725; H04L 12/741; H04L 29/06

(52) U.S. Cl. CPC H04L 45/306; H04L 65/1069; H04L 45/74

(57) ABSTRACT

Methods and systems for intelligent call routing are provided herein. In some embodiments, a method for intelligent call routing may include receiving a call request directed to a subscriber identifier associated with a plurality of devices, wherein the call request includes a caller identifier; determining one or more devices of the plurality of devices to which to route the call request based on a comparison of the caller identifier and address book information obtained from each of the plurality of devices; and routing the call to the one or more determined devices.

### BACKGROUND

1. Field

Embodiments of the present invention generally relate to call routing, and more specifically, to methods and systems for intelligent call routing to one or more relevant user devices.

2. Description of the Related Art

Some technologies support call signaling to multiple destinations. That is, multiple devices may be associated with a single phone number or other communication identifier. For example, a family of four may have a home account that may be associated with a home telephone, but also have a mobile app on each family member's smartphone that rings when a call is directed to the home account/phone number. Alternatively, a single user may have an account that is associated with multiple devices, each device associated with its own phone number or communication identifier. Typically, when a call request directed to a communication identifier is received that may be directed to multiple devices, all of the devices ring. However, the incoming call may be intended for one or more, but less than all, of the devices. For example, a family friend may call the home phone number wishing to speak with one of the parents in the family. If the call rings on the parents' phones as well as the children's phones, and one of the children answers, the call is wasted and may need to be place a second time in order to reach a parent.

Thus, there is a need for a method and system to provide a better way of routing calls to one or more relevant user devices.

### SUMMARY

Methods and systems for intelligent call routing are provided herein. In some embodiments, a method for intelligent call routing may include receiving a call request directed to a subscriber identifier associated with a plurality of devices, wherein the call request includes a caller identifier; determining one or more devices of the plurality of devices to which to route the call request based on one or more indicators of familiarity between the caller identifier and each of the plurality of devices; and routing the call to the one or more determined devices.

In some embodiments, a system for intelligent call routing includes a call router configured to receive a call request directed to a subscriber identifier associated with a plurality of devices, wherein the call request includes a caller identifier; determine one or more devices of the plurality of devices to which to route the call request based on one or more indicators of familiarity between the caller identifier and each of the plurality of devices; and route the call to the one or more determined devices.

In some embodiments, a computer readable medium is disclosed. The computer readable medium stores computer instructions that, when executed by at least one processor causes the at least one processor to perform the method for intelligent call routing.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for intelligent call routing, according to one or more embodiments of the invention;

FIG. 3 depicts a flow diagram of a method for intelligent call routing, according to one or more embodiments of the subject invention; and

FIG. 4 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for intelligent call routing. More specifically, when an incoming call request is received by a service provider, contact information and/or call history information associated with a user account are analyzed and used to route the call request to one or more most relevant devices associated with the user.

Upon receiving an incoming call request from a caller associated with a caller identifier, the contact information as well as call history information associated with each device is accessed. In some embodiments, the call is routed to each device that has the caller identifier in a contact list of the device. In some embodiments, the call is routed to each device that has the caller identifier in the call history of the device, meaning the device has been used to place a call or receive a call from the caller identifier in the past. In some embodiments, a familiarity score based on indicators of familiarity, such as a comparison of contact information and/or call history information with the caller identifier is calculated and associated with each device. In such embodiments, the call is routed to one or more devices with the highest score. For example, if the call history shows that a first device was recently used to call the caller identifier, but the call was unanswered, the call is routed to the first device, as the call is likely a callback. In another example, if the call history shows that a second device has been used to place a significant number of calls to the caller identifier, suggesting a high familiarity with between the caller identifier and the second device, the second device is assigned a high score. In yet another example, if both the first device and the second device received a number of calls from the caller identifier, but the calls to the second device last, on average, significantly longer than calls to the first device, the second device is assigned a higher score than the first device. Various parameters may be used to score each device in order to determine a level of familiarity of the device with the caller identifier.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any application that relies on or uses address books/contact directories may be used in embodiments consistent with the present invention without departing from the principles of the disclosure described herein. For example, access to the cloud address book may be provided via a browser of a user device. When a contact is modified in the cloud address book, the change is further reflected on the user device where the contact is a native contact, and further synchronized with the “owner” of the contact, such as GOOGLE, YAHOO!, or Exchange.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

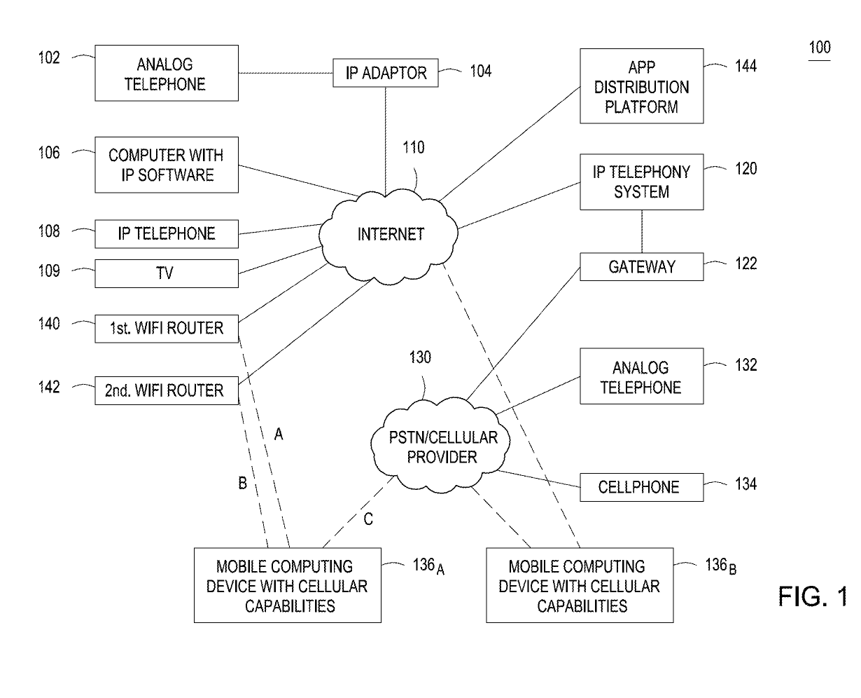

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a wireless local area network (WLAN) router based on the Institute of Electrical and Electronics Engineers' (IEEE) 802.11x or 802.16x standards. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as protocols based on (IEEE) 802.11x or 802.16x standards.

Similarly, mobile computing device with cellular capabilities 136B may also be coupled to internet 110 and/or cellular service provider 130. In some embodiments, mobile computing device 136B may be connected to internet 110 via a wireless local area network (WLAN) connection based on the Institute of Electrical and Electronics Engineers' (IEEE) 802.11x or 802.16x standards, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

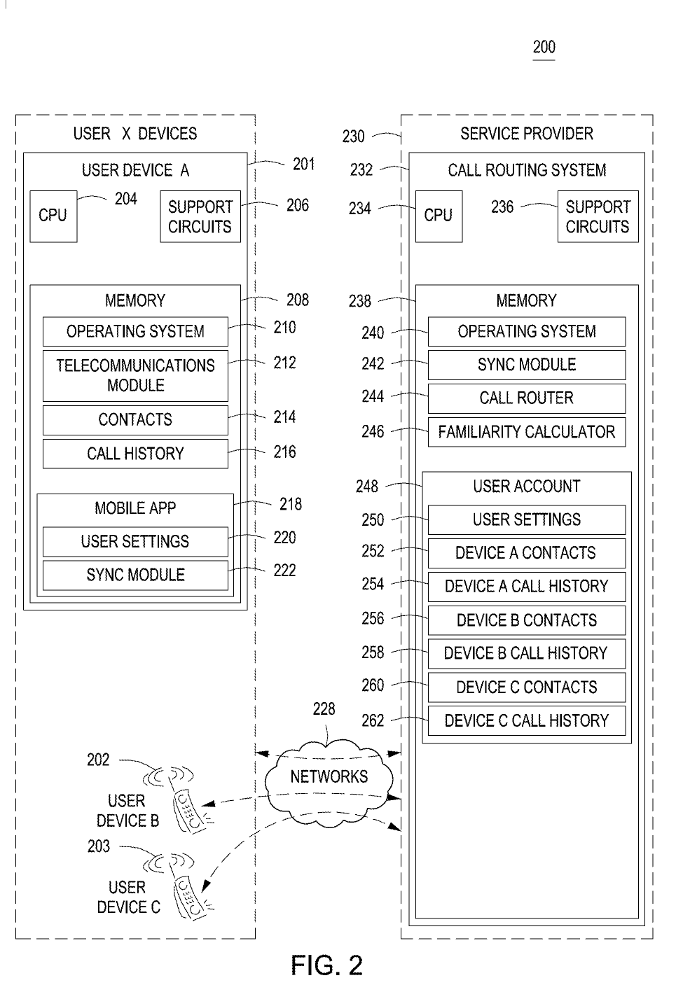

FIG. 2 depicts a block diagram of a system 200 for intelligent call routing, according to one or more embodiments. The system 200 comprises multiple user devices, such as user devices 201, 202 and 203, and service provider system 230 communicatively coupled via networks 228. In some embodiments, user devices 201, 202 and 203 may be mobile computing devices (e.g., 136A) associated with a user, and service provider system 230 may be IP telephony system 120 as described above in FIG. 1.

Each user device 201, 202 and 203 may comprise a Central Processing Unit (CPU) 204, support circuits 206, and memory 208. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 208 comprises at least one of Read Only Memory (ROM), Random Access Memory (RAM), disk drive storage, optical storage, removable storage and/or the like. In some embodiments, the memory 208 comprises an operating system 210, telecommunications module 212, contacts 214 (e.g., an address book), call history data 216, and a mobile app 218, such as a mobile extension telecommunication app. Call history data 216 includes information for each call made or received including, but not limited to, whether the call was incoming or outgoing, the caller identifier of the caller, if the call was incoming, the caller identifier of the person called, if the call was outgoing, the call status (e.g., whether the call was answered or unanswered), a length of each call, a time of the call, and the like.

The operating system (OS) 210 generally manages various computer resources (e.g., network resources, file processors, and/or the like). The operating system 210 is configured to execute operations on one or more hardware and/or software modules, such as Network Interface Cards (NICs), hard disks, virtualization layers, firewalls and/or the like. Examples of the operating system 210 may include, but are not limited to, various versions of LINUX, MAC OSX, BSD, UNIX, MICROSOFT WINDOWS, IOS, ANDROID and the like. In some embodiments, operating system 210 may include an application programming interface (API) which can be used to access and user device information and features (such as, for example, by mobile app 218).

Telecommunication module 212 may be used to facilitate, otherwise provide, communication services such as, for example, voice or video calling, SMS messages, email, or various other types of communication services provided by a service provider 230.

The mobile app 218 may be any app that uses address book information and call history information. In some embodiments, the mobile app 218 is a VoIP app that provides over-the-top (OTT) VoIP telephony services to an end-user. For example, in some embodiments, mobile app 218 may be a mobile extension application installed on each user device 201, 202 and 203 that can associate (e.g., link/charge) outgoing and/or incoming calls made from user devices 201, 202 and 203 to the same VoIP telephony account. In some embodiments, an end-user may download the mobile app 218 from service provider system 230, or from an app distribution system 144, and install the mobile app 218 on their device. Although the mobile app 218 is described herein as a separate stand-alone application, in some embodiments the mobile app 218 may be integrated into OS 210, and may use existing API calls provided by the OS 210 to access or control various features of user devices 201, 202, and 203.

In some embodiments mobile app 218 may include user settings 220 and sync module 222. In some embodiments, mobile app 218 may be used to configure user settings 220, which may be used to determine how to route a call received from a given contact. For example, a user may have device A, device B, and device C. The user may configure user settings 220 to define that a call from caller identifier 732-555-1234 should be routed to device B and device C. In some embodiments, when a user repeatedly does not answer calls for a given caller identifier, the user may be prompted whether the user wishes to block calls from the given caller identifier. If the user responds that calls from the caller identifier should be blocked, the information is stored in user settings 220. In some embodiments, the sync module 222 may be used to help manage and synchronize contact information (i.e., an address book) 214, call history 216, and user settings 220 with the service provider 230. In some embodiments, sync module 222 may encrypt all or a portion of the information sent to service provider 230 over network 228, or otherwise transmit the information in a secure format.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider system 230 may be a communication service provider, such as a VoIP service provider, that includes and maintains call routing system 232. In other embodiments, call routing system 232 may be a separate entity that provides routing services to service provider system 230, or to individual users, by agreement. Call routing system 232 may be used to manage/synchronize contacts, call history, and user settings across multiple devices associated with a user in order to identify to which devices an incoming call is to be routed. The call routing system 232 may include a Central Processing Unit (CPU) 234, support circuits 236, and memory 238. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 238 comprises an operating system 240, sync module 242, call router 244, familiarity calculator 246, and user account 248. The operating system (OS) 240 generally manages various computer resources (e.g., network resources, file processors, and/or the like). The operating system 240 is configured to execute operations on one or more hardware and/or software modules, such as Network Interface Cards (NICs), hard disks, virtualization layers, firewalls and/or the like. Examples of the operating system 240 may include, but are not limited to, various versions of LINUX, MAC OSX, BSD, UNIX, MICROSOFT WINDOWS, IOS, ANDROID and the like.

The user account 248 may include user settings 250, device A contacts 252, device A call history 254, device B contacts 256, device B call history 258, device C contacts 260, and device C call history 262. The user account 248 may also include a user identifier and device identifiers for each device associated with the user identifier and/or account. Each device identifier may be an International Mobile Equipment Identity (IMEI), a media access control (MAC) address, International mobile subscriber identity (IMSI), Integrated circuit card identifier (ICCID), serial number, or any identifier or combination of identifiers that uniquely identifies the user device.

In some embodiments, the sync module 222 of each user device 201, 202, and 203 may transmit information including contacts 214, call history 216, and user settings 220 to call routing system 232. In some embodiments, the sync module 222 transmits the information when the mobile app 218 is launched. In some embodiments, the sync module 222 transmits the information at predefined intervals, for example, every X hours or minutes. In some embodiments, the sync module 222 transmits the information after each call. Sync module 242 may store the received information as user settings 250, device A contacts 252, device A call history 254, device B contacts 256, device B call history 258, device C contacts 260, and device C call history 262. Sync module 242 may also request/receive additional call history information, such as call detail records (CDR) for each device from centralized CDR database or from an external source (not shown).

In operation, when a call request associated with a caller identifier is received, the call router 244 determines if there are user settings 250 configured by the user that identify rules for routing a call request from the caller identifier. For example, user settings 250 may state that a call from the caller identifier is to be routed to user device B 202 and user device C 203. If there are user settings 250 for the caller identifier, the call router 244 routes the call per the user settings 250.

In some embodiments, if there are no user settings 250 for the caller identifier, the call router 244 determines which of the devices 201, 202, 203 have the caller identifier of the incoming call request in the devices' contacts 214. The call router 244 accesses device A contacts 252, device B contacts 256, and device C contacts 260. For each device that includes the caller identifier in the contacts, the call router 244 routes the call to the device.

In some embodiments, the call router 244 may access device A call history 254, device B call history 258, and device C call history 262 to determine which of the devices 201, 202, 203 has placed a call to or accepted a call from the caller identifier in the past. The call router 244 may route the call to one or more devices that have the caller identifier in the call history. The call router 244 may look at the entire call history or only a certain period of time in the call history, for example, the previous X hours.

In some embodiments, the call router 244 uses the familiarity calculator 246 to calculate one or more relevant devices in which to route the incoming call request. Information from the call history and contact list is assigned a pre-defined value. The values may be totaled in order to identify one or more relevant devices. For example, if an outgoing call was placed from a device to the caller identifier within a predefined time period and the call went unanswered, it is determined that this is the caller returning a call, and the device from which the outgoing call was made may be assigned a higher value than is assigned to other devices that have not recently placed an outgoing call. If a number of calls to the caller identifier were made/received on a given device exceeds a predefined threshold, the device may be assigned a higher value than is assigned to other devices that do not meet the threshold. The length of calls to/from the caller identifier provide a value based on the length of the call, such that if calls to device A last on average one minute, and calls to device C last on average ten minutes, device C may be assigned a higher value than device A. If a number of outgoing calls from a device to the caller identifier exceeds a predefined threshold, the device may be assigned a higher value than is assigned to other devices that do not meet the threshold. If a number of incoming calls from the caller identifier were unanswered on a device, the device may be assigned a lower value than to a device there the same number incoming calls from the caller identifier were answered. If the caller identifier exists in the contacts of a device, the device may be assigned a higher value than a device in which the caller identifier does not exist in the contacts of the device. The values assigned to each device are totaled. In some embodiments, the call router 244 routes the call to the device with a highest score. In some embodiments, the call router 244 routes the call to the top X number of devices. Although, points and scores are described, those skilled in the art will appreciate that any type of ranking/priorities may be used based on these criteria.

For example, an incoming call is received. The user account is associated device A 201, device B 202, and device C 203. The caller identifier associated with the call is in the contact list of device A. As such, a value of, for example, 5 points may be added to the familiarity score of device A. In addition, the caller identifier is in the call history data of both device B and device C. However, the call history data of device B indicates that calls last, on average, less than one minute and the call history data of device C indicates that calls last, on average more than ten minutes. As such, a value of, for example, 3 points is added to the familiarity score of device B while, for example 10 points are added to the familiarity score of device C. However, the call history data for device B indicates that a call was recently placed to the caller identifier and the call was unanswered. As such, a high value of, for example, 25 points are added to the familiarity score of device B. The total familiarity scores are 5 points for device A, 28 points for device B, and 10 points for device C. In the present example, although device A has the caller identifier in its contact list and device C is used to make relatively lengthier calls to the caller identifier, because device B was recently used to place a call to the caller identifier and the call was unanswered, device B was assigned the highest familiarity score. In some embodiments, the call router routes the call request to the device having the highest familiarity score. In some embodiments, the call router routes the call request to one or more devices having a familiarity score above a predefined threshold.

In some embodiments, where the call router 244 determines that the call should be routed to multiple devices, the call router 244 may route the call request to all devices at the same time. In some embodiments, the call router 244 may route the call to a first device, and if the call is not answered after a pre-defined period of time, the call router 244 routes the call to a second device, and so on. In some embodiments, the call router 244 may route the call by sending, for example, a session initiation protocol (SIP) message, such as a SIP INVITE or a PUSH notification to all devices. In some embodiments, the call router 244 sends a SIP INVITE message or PUSH notification to a first device and if the call is not answered after a pre-defined period of time, the call router 244 sends a SIP CANCEL message to the first device and sends a SIP INVITE or a PUSH notification message to a second device, and so on. The details and functionality of SIP can be found in the Internet Engineering Task Force (IETF) Request for Comments (RFC) Paper No. 3261 entitled, “SIP: Session Initiation Protocol,” that is herein incorporated in its entirety by reference. The call router 244 may send a session initiation protocol (SIP) message, or other type of telephony signaling message that may be used to establish a VoIP call, a packet switched telephone network (PSTN) call, or a cellular phone network call. Although SIP messages are described above, messages/data packets from any Transmission Control Protocol (TCP) or User Datagram Protocol (UDP) based protocol, or proprietary protocol, may be used with embodiments described herein.

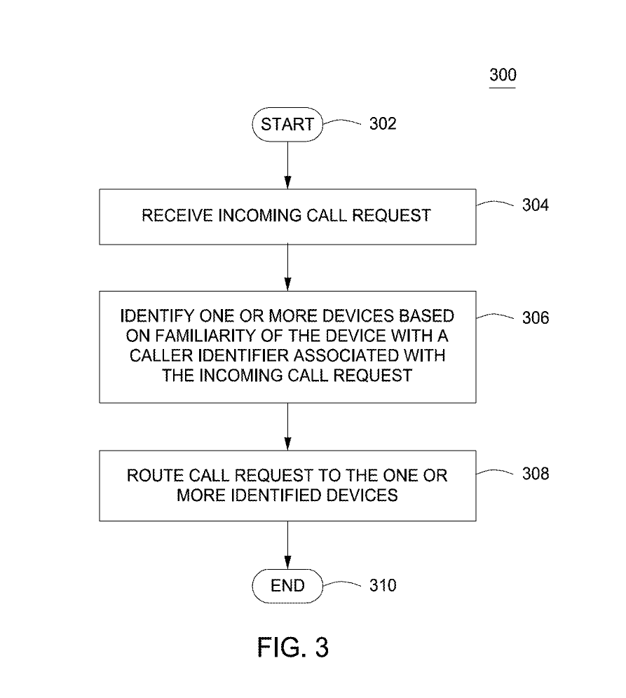

FIG. 3 depicts a flow diagram of a method 300 for intelligent call routing, according to one or more embodiments of the subject invention. Prior to invoking method 300, the contacts 214, call history 216, and user settings 220 on a given device may be synchronized with the call routing system 232. For example, when a mobile communication app is launched from a user device, the contacts 214, call history 216, and user settings 220 on the given device from which the app is launched may be synchronized with user account 248 on the service provider's call routing system 232. If call history for a given device is unavailable, due to for example, technological limitations, sync module 242 may retrieve call history information for the device from other sources, such as CDRs from a call detail records database. The sync module 242 may submit an HTTP request to receive the information. The method 300 starts at step 302 and proceeds to step 304, where an incoming call request is received.

In some embodiments, the incoming call is placed to a telephone number or other communication identifier associated with multiple devices. For example, the telephone number may be a home telephone number that is linked to a plurality of mobile devices. Each mobile device may have a mobile app installed that is designed to receive a call request for the incoming call that was placed to the home telephone number. In another example, the incoming call may be placed to a telephone number of a user whose account is linked to multiple devices. The incoming call request is associated with a caller identifier (e.g., a telephone number or other communication identifier).

At step 306, the call router 244 identifies one or more of the plurality of devices which are relevant to the caller identifier. In other words, the call router 244 identifies devices where the caller would more likely wish to be directed. In some embodiments, if the user has manually configured user settings for the caller identifier associated with the call request, the devices specified in the user setting are identified as the relevant devices. For example, a user may configure settings such that a call from a specific caller identifier is directed to one or more, but less than all devices. For example, if a family of four has a home phone number, and each of the parents and children has the mobile app on their smartphone, the user may configure calls from, for example, a doctor with a caller identifier of 732-555-9876 to be directed only to the devices of the parents.

In some embodiments, if no user settings are configured for the caller identifier associated with the call request, the call router 244 determines whether the caller identifier is present in the contacts list of one or more devices in the plurality of devices. The devices that have the caller identifier in the contacts list are identified as relevant devices. In some embodiments, the call router 244 identifies relevant devices based on the call history of the devices. The devices that have been used to place a call or have received a call from the caller identifier have the caller identifier in the call history of the device and are identified as relevant devices.

In some embodiments, the call router 244 uses both the contacts and call history of the devices to identify relevant devices. The call router 244 uses the familiarity calculator 246 to assign a score to each of the devices based on the contacts and call history. A given device is assigned a value for each data point that indicates a level of familiarity between the caller identifier and the device. A total score based on the values for each data point is assigned to each device indicating a level of familiarity between the device and the calling identifier. Based on the score assigned to each device, one, some or all devices may be identified as relevant. For example, if the call history for a device shows that an outgoing call to the caller identifier was placed from the device within a predefined period of time, for example X minutes/hours and the outgoing call was unanswered, it is determined that the caller associated with the caller identifier is returning a call and the device is assigned a very high score relative to the scores assigned to other devices. In some embodiments, the scores of other devices are not calculated and the device to which the call is being returned is the only device identified as relevant.

Other data may be involved in calculating a score of each device. For example, a large number of calls received from the caller identifier may add a higher value to the device on which the calls were received relative to the value assigned to other devices. However, a large number of calls received from the caller identifier that last longer than a predefined threshold may add a higher value to the device relative to a smaller value added to a device that received a large number of calls lasting less than the predefined threshold. For example, if a large number of calls to device A last less than 2 minutes, but a large number of calls to device B last, on average, over 10 minutes, then device B receives a higher value than device A. Outgoing calls from a device to the caller identifier adds a higher value to a device's score. However, incoming calls that were unanswered by device may add a low value to the device's score. An entry for the caller identifier in the contact list of a device may add a higher value to a device, relative to the value added to a device that does not include an entry in the contact list.

When the values for each device are totaled, the devices with the highest scores are identified as the relevant devices. In some embodiments, the device with the highest score is identified as the relevant device. In some embodiments, devices with a score over a predefined threshold are identified as the relevant devices. In some embodiments, all devices are identified as relevant devices and the score of each device determines in what order the devices are sent the call request.

At step 308, the call router 244 routes the call request to the identified devices. In some embodiments, the call request is a SIP INVITE message sent all identified devices using the device identifier stored in the user account. In some embodiments, the call request is sent to a first device, for example, a device with a highest familiarity score and if the call request is unanswered, the call request is sent to a second device, for example with a next highest familiarity score. The method 300 ends at step 310.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

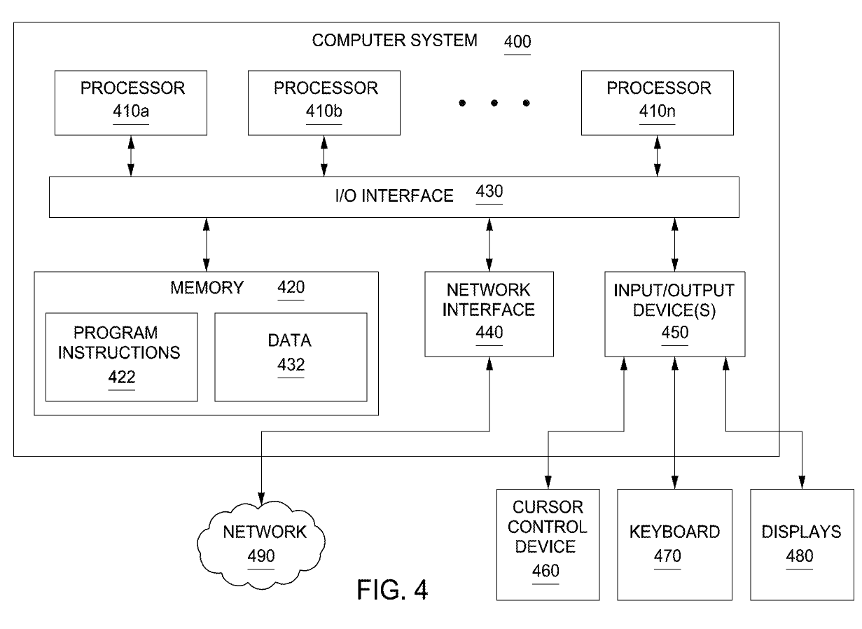

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement the method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the operations and methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for intelligent call routing, comprising:
receiving a call request directed to a subscriber identifier associated with a plurality of devices, wherein the call request includes a caller identifier;
determining one or more devices of the plurality of devices to which to route the call request based on one or more indicators of familiarity between the caller identifier and each of the plurality of devices; and
routing the call to the one or more determined devices.

2. The method of claim 1, wherein the one or more indicators of familiarity are based on a comparison of the caller identifier and address book information obtained from each of the plurality of devices.

3. The method of claim 1, wherein the one or more indicators of familiarity are based on a comparison of the caller identifier and call history data associated with each of the plurality of devices.

4. The method of claim 1, wherein determining the one or more devices to which to route the call request to includes determining a first familiarity score for each device based on the one or more indicators of familiarity, wherein the first familiarity score is based on a comparison of the caller identifier and address book information obtained from each of the plurality of devices.

5. The method of claim 4, further comprising determining a second familiarity score for each device based on a comparison of the caller identifier and call history data associated with each of the plurality of devices.

6. The method of claim 5, further comprising:
determining a total familiarity score for each device based on the first and second familiarity scores for each device; and
selecting at least one device with a highest total familiarity score as the determined one or more devices.

7. The method of claim 5, wherein the second familiarity score is based on at least one of:
a number of calls to or from the caller identifier;
a length of calls to or from the caller identifier; and
a determination of whether previous calls from the caller identifier were answered or unanswered.

8. The method of claim 5, wherein the familiarity score is recalculated for each incoming call request based on most recent data of each device.

9. The method of claim 1, wherein prior to receiving the call request, the method further comprises obtaining, from each of the plurality of devices associated with the subscriber identifier, address book information and call history data stored on each device.

10. A system for intelligent call routing, comprising
a call router configured to receive a call request directed to a subscriber identifier associated with a plurality of devices, wherein the call request includes a caller identifier; determine one or more devices of the plurality of devices to which to route the call request based on one or more indicators of familiarity between the caller identifier and each of the plurality of devices; and route the call to the one or more determined devices.

11. The system of claim 10, wherein the one or more indicators of familiarity are based on a comparison of the caller identifier and address book information obtained from each of the plurality of devices.

12. The system of claim 10, wherein the one or more indicators of familiarity are based on a comparison of the caller identifier and call history data associated with each of the plurality of devices.

13. The system of claim 10, wherein the call router is further configured to determine the one or more devices to which to route the call request to by determining a first familiarity score for each device based on the one or more indicators of familiarity, wherein the first familiarity score is based on a comparison of the caller identifier and address book information obtained from each of the plurality of devices.

14. The system of claim 10, wherein the call router is further configured to determine the one or more devices to which to route the call request to by determining a second familiarity score for each device based on a comparison of the caller identifier and call history data associated with each of the plurality of devices.

15. The system of claim 14 wherein the call router is further configured to:
determine a total familiarity score for each device based on a first and second familiarity scores for each device; and
select at least one device with a highest total familiarity score as the determined one or more devices.

16. The system of claim 14, wherein the second familiarity score is based on at least one of:
a number of calls to or from the caller identifier;
a length of calls to or from the caller identifier; and
a determination of whether previous calls from the caller identifier were answered or unanswered.

17. The system of claim 15, wherein the total familiarity score is recalculated for each incoming call request based on most recent data of each device.

18. A non-transitory computer readable medium for storing computer instructions that, when executed by at least one processor causes the at least one processor to perform a method for intelligent call routing, comprising:
receiving a call request directed to a subscriber identifier associated with a plurality of devices, wherein the call request includes a caller identifier;
determining one or more devices of the plurality of devices to which to route the call request based on one or more indicators of familiarity between the caller identifier and each of the plurality of devices; and
routing the call to the one or more determined devices.

19. The computer readable medium of claim 18, wherein the one or more indicators of familiarity are based on at least one of a comparison of the caller identifier and address book information obtained from each of the plurality of devices or a comparison of the caller identifier and call history data associated with each of the plurality of devices.

20. The computer readable medium of claim 19, further comprising:
determining a total familiarity score for each device based on a first familiarity score and a second familiarity score for each device; and
selecting at least one device with a highest total familiarity score as the determined one or more devices,
wherein the first familiarity score for each device based on the comparison of the caller identifier and address book information obtained from each of the plurality of devices, and wherein the second familiarity score for each device based on the comparison of the caller identifier and call history data associated with each of the plurality of devices.
